(19) United States
(12) Patent Application Publication
(10) Pub. No.: US 2004/0255029 A1
(43) Pub. Date: Dec. 16, 2004

(54) Discovery and control protocol for intelligent displays

(75) Inventors: Todd R. Manion, Redmond, WA (US); Robert D. Donner, Sammamish, WA (US)

Correspondence Address: KLARQUIST SPARKMAN LLP, 121 S.W. SALMON STREET, SUITE 1600, PORTLAND, OR, 97204, US

(73) Assignee: Microsoft Corporation

(21) Appl. No.: 10/463,826

(22) Filed: Jun. 16, 2003

(51) Int. Cl. G06F 15/16

(52) U.S. Cl. 709/227

(57) ABSTRACT

During seminars, speakers often need to interrupt their presentations in order to switch between laptops that plug into a projector. Participants move around the room in order to accommodate a cable tethered to a projector. Instead, a control point discovers an intelligent display over a network. In one example, upon a user selecting an intelligent display connection icon, the control point establishes a connection with the intelligent display, and sends content to be displayed at the intelligent display. A Device Control Protocol (DCP) is defined according to the Universal Plug and Play (UPNP) protocol. UPnP is used to discover and control intelligent displays, over a wired or wireless network. Methods in a service description are used by control points to connect with, control, and determine the status of an intelligent display. Other defined methods change the state or settings of the intelligent display.

### TECHNICAL FIELD

The technical field relates to discovering and controlling intelligent displays over a network.

### COPYRIGHT AUTHORIZATION

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Sharing information is not as efficient today as it could be. For example, two presenters at a meeting often need to interrupt their presentations in order to switch between laptops that plug into a projector. Participants move around the room in order to accommodate a cable tethered to a projector.

### SUMMARY OF THE INVENTION

The described technologies provide methods and systems for connecting a control point to an intelligent display.

In one example, a control point discovers and connects to an intelligent display, and displays content on the intelligent display, over a network or wireless network. During discovery and control, the control point and intelligent display communicate a device description and a service description. The control point sends control messages to the intelligent display according to the service description.

In another example, a control point discovers an intelligent display over a network automatically, and upon a user selecting an intelligent display connection icon, the control point establishes a connection with the intelligent display, and sends content to be displayed at the intelligent display. In one such example, multiple control points are placed in a connection list and each waits until they gain control over the intelligent display. Thus increasing productivity by reducing the time required to connect to and control the intelligent display, and without switching an intelligent display cable between control points.

In another example, a control point discovers plural intelligent displays (e.g., a projector, plural monitors, or plural laptops), and displays content on those plural intelligent displays. When the intelligent display is another user's laptop, a pop-up window requests authorization from that user to receive projected content.

In another example, the technologies define a Device Control Protocol (DCP) using Universal Plug and Play (UPnP). UPnP is used to discover and control intelligent displays, over a wired or wireless network. Methods in a service description are used by control points to connect with, control, and determine the status of an intelligent display. Other defined methods change the state or settings of the intelligent display.

Additional features and advantages will be made apparent from the following detailed description of the illustrated embodiments, which proceeds with reference to the accompanying drawings.

### BRIEF DESCRIPTION OF THE DRAWINGS

FIG. 1 is a block diagram showing an overview of an exemplary control point and intelligent display communicating.

FIG. 2 is a diagram of an exemplary message passing scenario.

FIG. 3 is a continuation of FIG. 2.

FIG. 4 is an exemplary block diagram showing an overview of an exemplary control point and intelligent display using a generic rendering protocol.

FIG. 5 is a diagram of an exemplary graphical user interface.

FIG. 6 is a schema of a device description.

FIG. 7 is a continuation of FIG. 6.

FIG. 8 is an exemplary diagram of communicating control points and an intelligent display.

FIG. 9 is a service description schema.

FIG. 10 is a continuation of FIG. 9.

FIG. 11 is a continuation of FIG. 10.

FIG. 12 is a continuation of FIG. 11.

FIG. 13 is a continuation of FIG. 12.

FIG. 14 is a display capabilities schema.

FIG. 15 is a continuation of FIG. 14.

FIG. 16 is a string formed according to the schema of FIG. 14.

FIG. 17 is a display settings schema.

FIG. 18 is a block diagram of a computer system that may be used to implement a method, apparatus, and system of the described technologies.

### DETAILED DESCRIPTION

### Exemplary Overview

Universal Plug and Play (UPnP) is a standards body devoted to the discovery and control of devices. Each device submitted to the standards body must have a corresponding device description document (DD) and service description (SD) document. Collectively, these documents are referred to as a Device Control Protocol (DCP). The following described technologies include a DCP for intelligent display devices (e.g., television, projector, computer monitors, PDAs, etc.).

The first aspect of the DCP is the device description document. This document details the services required to implement a UPnP compliant intelligent display. This particular DCP specifies a power service and a projector service. The device description is described further below.

The second aspect of the DCP is the service description document. Service description documents delineate the methods needed for a device. Each service description document entails a collection of methods a device can expose. For example, a projector service description document delineates the methods that may be implemented in an intelligent display device. The methods in Table A are supported by intelligent displays, and the methods in Table B are optionally supported by an intelligent display. Of course, an example intelligent display may support a set of methods from Table A and/or B.

TABLE A

Connect ( [IN] ConnectionString, [IN] ConnectionName,
[OUT] SessionToken)
Disconnect ( [IN] SessionToken)
GetDisplayCapabilities ( [OUT] DisplayCapabilities)
GetProjectorState( [OUT] ProjectorState)

TABLE B
GetProjectorName ( [OUT] ProjectorName)
GetConnectionList ( [OUT] ConnectionList)
GetCurrentConnection ( [OUT] ConnectionName)
SetCurrentConnection ([IN] SessionToken, [IN] ConnectionName)
GetDisplaySettings ([IN] ConnectionName, [OUT] DisplaySettings)
SetDisplaySettings ([IN] SessionToken, [IN] DisplaySettings)
HideConnection([IN] SessionToken)

The “Connect” method sets up a connection to an intelligent display, while the “Disconnect” method tears down a connection. In addition, the following methods exist for determining the capabilities/settings of the device: “GetDisplayCapabilities”, “GetProj ectorName”, “GetConnectionList”, “GetCurrentConnection”, “GetDisplaySettings”. Also, the following methods exist to change the settings of the device: “SetCurrentConnection”, “SetDisplaySettings”. The “HideConnection” method allows a control point to hide or blank an intelligent display. A more detailed description of each method is discussed below.

An example intelligent display and control point(s) architecture uses several technologies. In one example, an intelligent display device uses a terminal rendering component (e.g., Terminal Services, from Microsoft Corp.) to render the display content and UPNP to discover and control the device. The intelligent display device exposes the methods the control point will use to control the device and establish a display connection via Terminal Services. The UPnP protocol is used for discovery of the device, and the device is hosted within the UPnP device host service. A remote assistance protocol (e.g., Salem, from Microsoft Corp.), generates the tickets used to connect to a Terminal Services server. For example, the Terminal Services server is responsible for the protocol used to “stream” a control point's screen to an intelligent display. A shell is responsible for a control point user experience. In one example, Windows CE from Microsoft Corp., is used as an operating system for a projector, and a remote desktop rendering protocol (e.g., Remote Desktop Protocol (RDP), a layer of Salem from Microsoft Corp.™), understands the remote assistance “tickets” used for establishing a connection. For example, tickets can be used as described in “Improved Data Projection System and Method,” U.S. patent application Ser. No. 10/179431, filed Jun. 25, 2002, which is incorporated herein by reference.

### Exemplary System

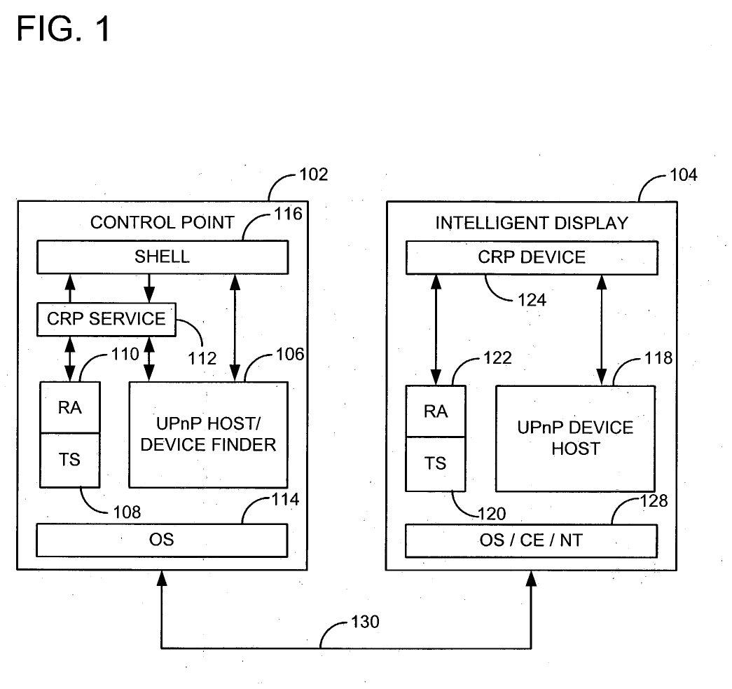

FIG. 1 shows an overview of a control point 102, and an intelligence display 104. A control point could be a laptop, PDA, or other electronic controlling device. An intelligent display could be a projector, a monitor, or other electronic display. The control point and the intelligent display have several technologies operating on them. For example, the control point includes a device discovery and control protocol 106, that allows it to define, discover and control devices (e.g., Universal Plug and Play (UPnP)). The control point also includes a remote terminal rendering component 108 (e.g., Terminal Services, Microsoft Corp.™), that allows it to render content on a remote display. Additionally, the control point includes a remote assistant component 110 (e.g., Remote Assistance, Microsoft Corporation™), that allows it to generate a unique ticket used in establishing a remote terminal session. The control point also includes an application component 112 (Conference Room Projector Service (CRP), from Microsoft Corp.™), which allows the application to create the displayable content for the intelligent display. However, almost any application can be used to create displayable content (e.g., Word, Power Point, Excel, from Microsoft Corp.™), as well as any other source or audio-video feed (e.g., video movies, cable, broadcast TV, etc.). The control point also includes an operating system 114, that supports the described components with system services. Finally, the control point includes a shell component 116 that provides the graphical user interface experience for the control point.

Similarly, the intelligent display includes several technologies that allow it to operate. The intelligent display includes a device host protocol 118 (e.g., UPnP device host protocol), that exposes the intelligent display for discovery and control. The intelligent display also includes a terminal services client component 120, that allows it to receive content from a remote source and display it. Further, the exemplary intelligent display 104 includes a remote assistant client component 122, used to receive a ticket from the control point to establish a terminal session with the control point. The intelligent display includes intelligent display control software 124 that includes the methods for controlling the display. Finally, the intelligent display includes an operating system 128, that supports the other components with system services.

Thus the control point UPnP component exposes an API for the methods described in Table A (and optionally, one or more methods from Table B). An application or shell uses this API to control the remote intelligent display. The UPnP component packages the API method calls into XML strings according to the device description and/or service description, and streams them over the network (wireless or not) to the UPnP component on the intelligent display 118. The UPNP component 118 on the intelligent display un-packages the XML strings and invokes the actual intelligent display control methods 124.

The display content is created at the control point 112 (e.g., CRP, application, video source, etc.), and delivered over the network via a remote desktop protocol 110, 108, 122, 120, or other remote rendering protocol, where it is displayed via the client side display component 124. Thus, discovery and control protocol is kept separate from the content rendering protocol.

### Exemplary Message Passing

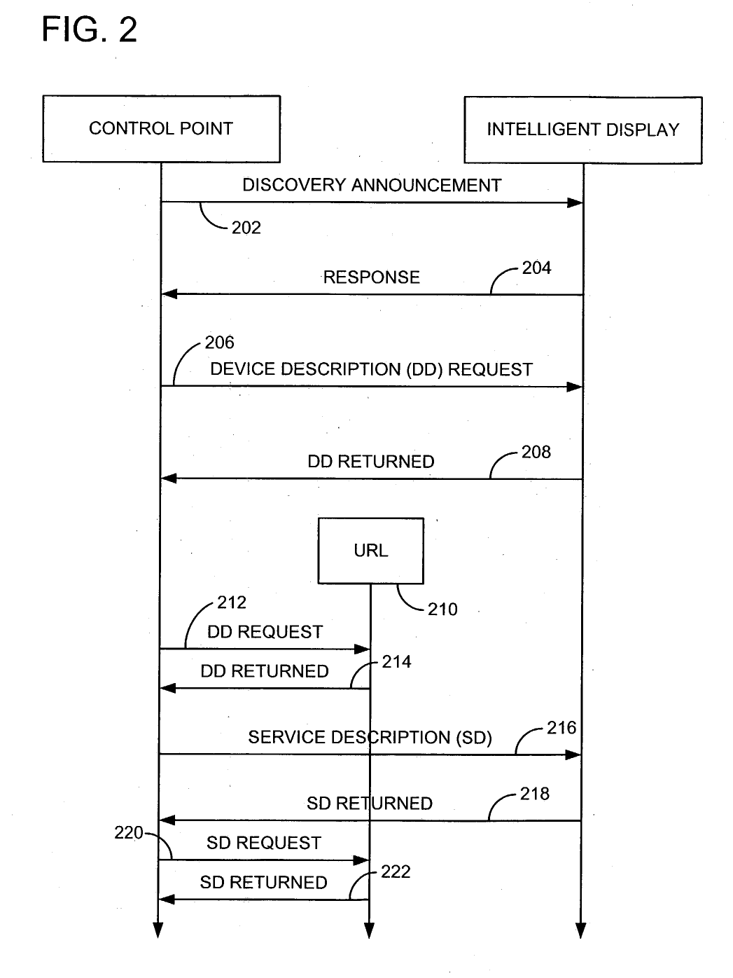

FIG. 2 is an example of discovery and control messages passed between a control point and an intelligent display.

At 202, the control point sends out a discovery announcement. The discovery announcement is a multi-task based discovery announcement sent according to the simple service discovery protocol (SSDP), of the UPnP standard, which is the official way of being able to discover devices. In this case, the discovery announcement is a specific request for an intelligent display. In another case, any discoverable devices may respond, and the response is used to determine the type of device that responded.

At 204, the intelligent display after having received the discovery announcement, responds to the announcement. The response 204 includes a pointer to an intelligent device description.

At 206, the control point requests the device description document.

At 208, the intelligent display sends the device description document to the control point.

In another example, after the discovery announcement 202, and response from the intelligent display containing the pointer to the device description document 204, if the pointer to the device description is a pointer to a URL 210 other than the intelligent display, the control point then requests the device description document from that URL 212, and the URL 210, responds by returning the device description document 214.

At this point, the control point has the device description document, which contains information about where to obtain the service description document. The service description enumerates the methods that can be called to control the intelligent display.

At 216, the control point then uses the reference in the device description document to request the service description document 216, from the intelligence display.

At 218, the intelligent display returns the service description document.

In another example, the device description document describes the location of the service description document at a URL 210, other than the intelligent display.

At 220, if the device description document points to a URL 210 other than the intelligent display to obtain a copy of the service description document, the control point requests the service description document from that URL 210. The URL where the device description need not be the same URL where the service description is located.

At 222, the URL 210 returns the service description document to the control point.

The control point now contains a copy of the device description document and the service description document, whether they were obtained from an intelligent display or a URL, or both. In one example, when a control point is a laptop computer and a wireless network is used to obtain the device description document and or the service description document, it may be more efficient to obtain them directly from the intelligent display. Of course, a control point may already have a copy of one or both of these documents from a recent use or for other reasons (e.g., that control point may also be an intelligent display). In such a case, it would be unnecessary to download them again. In a general sense, UPNP is meant to be a peer-to-peer arrangement, rather than requiring a third party host. Although, a third party host may be beneficial in certain cases if the control point or the intelligent display has limited memory or other limitations. With the service description document now in the control point, the control point has the methods it needs in order to control the intelligent display.

In FIG. 2 the control point discovered the intelligent display. This was accomplished with a discovery announcement 202, and a response from an intelligent display 204. However, in another example, the control point would merely listen to the network and wait for the intelligent display to advertise or announce itself. In such an example, the control point would then use the advertisement 204, in order to obtain the device description document 206, and then from the pointer in the device description document, obtain a copy of the service description document 218. As before, the response 204 and the device description document 208, 214, may instead point to a URL 210 other than an intelligent display URL. In such an example, the device description request 212, and the service description request 220, are requested and received from the URL 210. Of course, a given example could also receive the device description from the intelligent display 208, and the service description from the URL 222, or the device description could be received from the URL 214, and the service description could be received from the intelligent display 218.

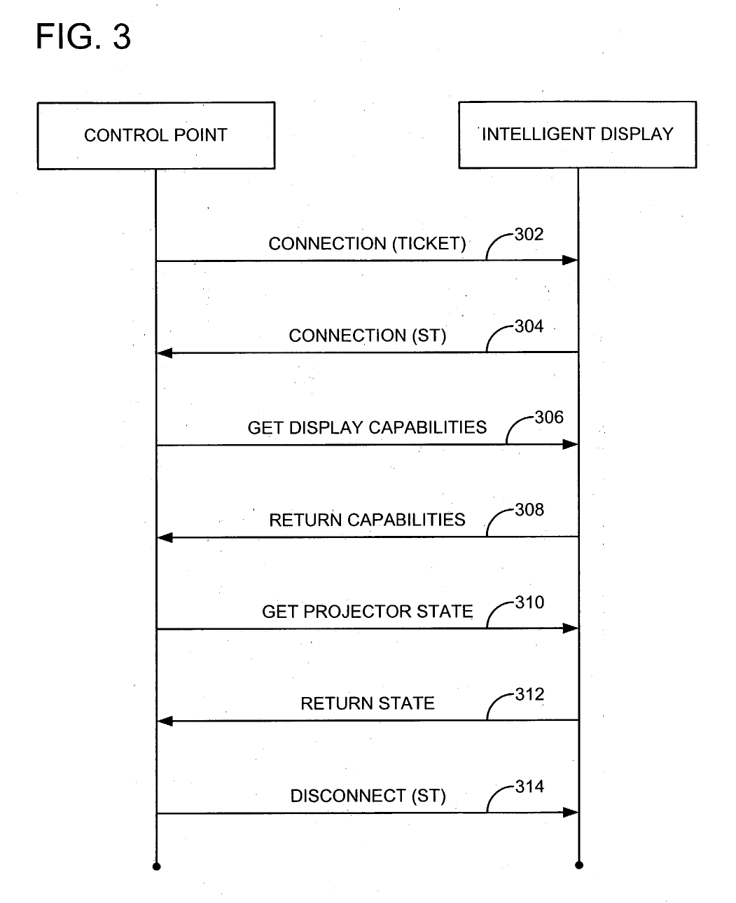

The scenario discussed with respect to FIG. 2 continues in FIG. 3. The service description describes a number of method calls that the control point can make on the intelligent display. Any intelligent display supporting this discovery and control protocol will support a connection method, a disconnect method, a get display capabilities method, and a get projector state method. Optionally, an intelligent display implementing the described protocol may also include a get projector name method, a get connection list method, a get current connection method, a set current connection method, a get display settings method, a set display settings method, and a hide connection method. Once the service description is received at the control point, the set of methods available to call on the discovered intelligent display are available to the control point.

The device discovery control protocol 106, exposes the methods described in the service description. Before attempting to connect to the intelligent display, the graphical user interface shell 116 and/or application 112, requests a ticket (not shown) from the remote assistance component 110.

At 302, the shell 116 or application 112, calls the connection method on the UPnP supplied component 106, and the connection call includes an input parameter with the ticket (e.g., “[IN] ConnectionString”). Any method that produces a unique token could be used to create the ticket. In this example, the ticket is a stream of a binary large object (BLOB), but other formats can be used. For example, the ticket could include an IP address, a user identification, and/or other security information used to establish and subsequently identify an established terminal server session. The connection method call is sent across a network 130, to the UPnP device host component 118. The UPNP device host calls the connection method on the intelligent display control software component 124. The intelligent device control software calls remote assistance 122, on the intelligent display side, which establishes a terminal services client session 120, at the intelligent display. This completes a rendering session connection between the intelligent display terminal services client 120 and the control point terminal services server 108, which is used to stream rendering from the control point to the intelligent display. Once the terminal services session is established, the intelligent display is rendered according to the terminal services protocol. As previously stated, the UPrlP device host 118, calls the connection method on the intelligent display control component 124, and the call includes the ticket which is later used by terminal services to establish display rendering.

Additionally, in response to the connection call made by the UPnP device host 118, the intelligent display control component 124 returns an output parameter containing a session token. The session token identifies the discovery and control session, as opposed to the rendering session.

At 304, the connection method call returns the session token back through the network connection 130, and the shell 112 or application 116 receives the session token as an output parameter to the connection call made on the UPNP component 106.

Thus an input parameter containing a ticket generated by remote assistance is input to the UPNP component in the connection call, and a session token is received as an output parameter in response to the connection call. The session token identifies what particular session is in control of the intelligent display at any particular time. If the intelligent display has one control point presently rendering, and one or more other control points waiting to render, the session token held by each control point allows the intelligent display to manage its sessions. In such an example, a control point that is presently rendering to the intelligent display, can change display settings, and a control point that is waiting to render, can obtain and set intelligent display settings that will be used to render when it obtains control of the intelligent display. So the intelligent display can hold state of multiple control points if desirable, which can reduce transition time between presenters. Thus the control now has the session token which is required to invoke a few of the methods in the service description.

At 306 the control point calls the get display capabilities method which streams the request across to the intelligent display.

At 308, the intelligent display returns the display capabilities. The control point can use these capabilities in order to manage the video and/or audio content that it streams to the intelligent display using a rendering protocol.

At 310, the control point obtains a state of the projector.

At 312, the state is returned to the control point. For example, if a control point determines that the projector is in a desirable state, it can begin streaming content to the intelligent display, and when the control point is done streaming content, it can release control of the intelligent display.

At 314, the control point calls the disconnect method, which includes the session token identifying the control point, so the intelligent display knows that the control point in charge of it at that time has released control. Thus the disconnect method is one of the methods that requires the second token as input.

Optionally, the intelligent display may implement other methods as described above and these methods can be called on the intelligent display according to the service description document. Typically methods that change the state of the intelligent display for a given control point require the session token as a method of determining that the correct party is changing the state as shown by the session token. For example, the session token can be required as input to the set current connection, the set display settings method, and the hide connection method.

### Exemplary Rendering as Separate from Discovery and Control

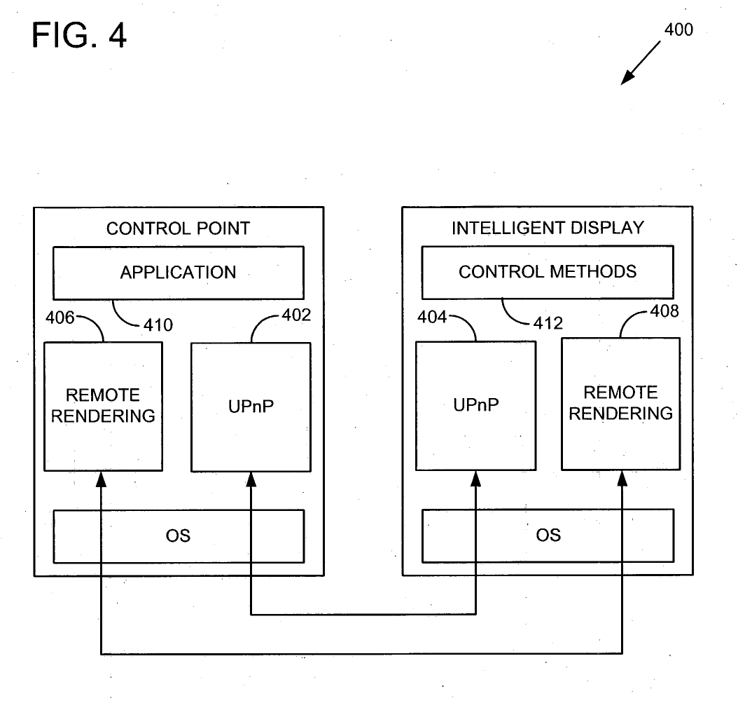

The discussion accompanying FIG. 1, described remote assistance and terminal services as the method for delivering the intelligent display content from the control point to the intelligent display. However, another example could implement another rendering methodology, yet still use the described DCP. As shown in FIG. 4, the UPNP DCP protocol 402-404, described herein supports the discovery and control of the intelligent display, but another rendering method is used to deliver the content from the control point to the intelligent display 406-408.

Specifically, the rendering components are separate from the UPnP components, so that any rendering methodology could later be substituted or augmented without requiring control changes. Thus a control point can use any intelligent display that implements the methods 412, prescribed in the UPNP device document and service document.

For example, a control point may have multiple rendering technologies available, and may render the display content according to either of the available technologies while using the same UPNP protocol described herein. The rendering may occur, for example, with an HTML technology, an RDP technology, a variation of an MPEG technology, or any other audio-visual rendering technologies.

Further because discovery and control is kept separate from rendering, the rendering or the discovery and control protocol can be changed at any time without affecting the other. For example, discovery could be implemented by typing in an IP address of the projector or intelligent display, where the IP address is simply posted on the front of the projector or display. Additionally, for a subsequent discovery iteration, the IP address could be displayed from a memory of prior used IP addresses. Further, an intelligent display manufacturer specific discovery and control protocol could be developed for a specific intelligent display and used in place of the UPnP protocol.

Additionally, the discovery is also implemented by browsing a directory of available displays, and the service description is obtained and used once a display is selected from the directory. Thus discovery can be viewed separately from control. For example as discussed with respect to FIG. 2 above, instead of the control point sending out a discovery announcement, the intelligent display could send out an availability announcement.

### Exemplary Graphical User Interface

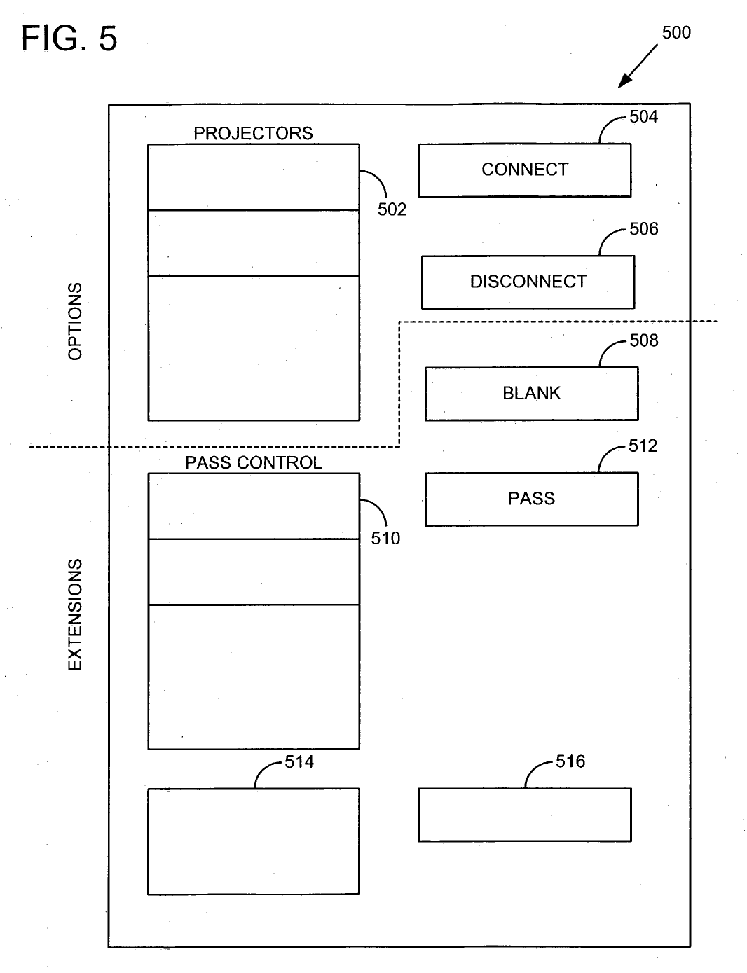

FIG. 5 is an exemplary graphical user interface (GUI) for requesting access to intelligent displays. The graphical user interface 500 is generated by a shell or application component (e.g., 410). Of course, in another example the GUI 500 may also be a component generated by the UPNP presentation layer. The presentation layer is a UPnP standardized interface for presenting graphical control for discoverable and controllable devices. However the component generating the GUI 500 could also be a third party component. For example a projector manufacturer may create a component that has features beyond those described in the UPnP protocol, and thus may prefer to create their own graphical component.

For example, upon entering a conference room a user may click on an intelligent display icon (not shown) in the tray at the bottom of their operating system window. In this example, in response to clicking the icon, a GUI 500 is generated which includes a list of one or more available discovered intelligent displays 502 (which may include other control devices equipped with intelligent display functionality). After selecting one or more intelligent displays from the list 502, a user clicks on an icon 504 in order to connect to and create a session with the selected intelligent display(s). Later, upon completion of the session, the user clicks on the disconnect icon 506, in order to release the intelligent display.

Additional GUI features could, for example, include a blank icon 508, that allows a user to blank the intelligent display presentation while they make further adjustments to the content of their presentation. Another feature could obtain and display a list of other control points that have sessions pending with the intelligent display. For example, the list could be in a window 510, and the user could select another control point in the list 510 and then click a “pass” control icon 512, in order to pass intelligent display control to another control point selected in the list 510. Other icons could include a window 514 for obtaining state information about the intelligent display or changing state information about the intelligent display, and selecting 516 to change state. The window 514 could also include ways of displaying device capabilities or selecting and changing device settings.

### Exemplary Device Description Document

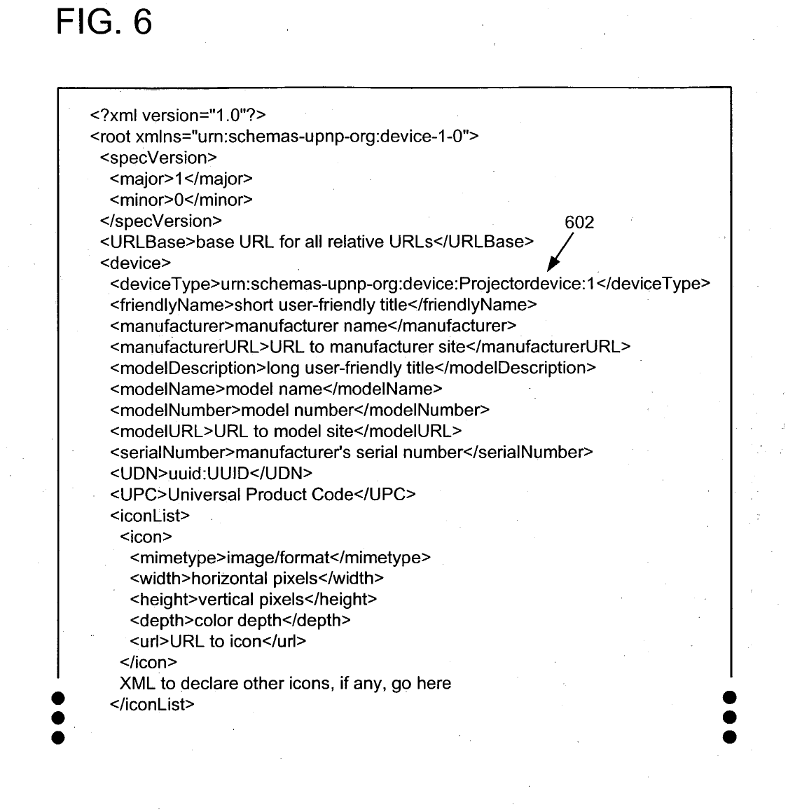

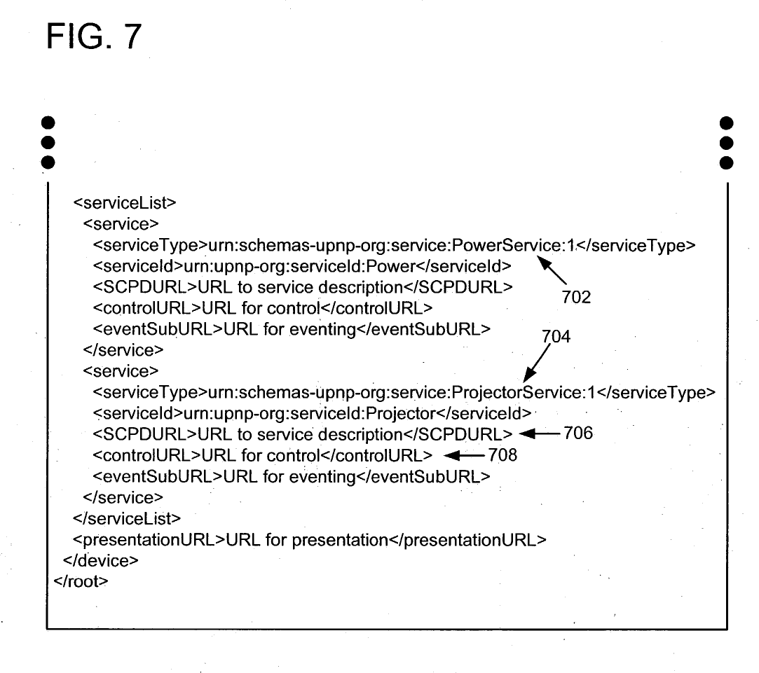

FIGS. 6-7 is an exemplary device description schema. This device description is compliant with the Universal Plug and Play Architecture, Version 1.0, and provides a way of obtaining a service description 706, defining functionality including connecting to a projector, disconnecting from a projector, retrieval of projector's resolution capabilities, setting of projector's resolution (via a connect request), retrieval of a projector's color depth capabilities, setting of pro jector's color depth (via a connect request), and determine whether or not the projector is connected. Schemas and strings formed according to schemas, are also known as “data structures.”

As shown in FIG. 6, the device type 602 identifies the device type that this device description document represents. The “<deviceType . . . >” string is the full name, and can be referred to as “Projectordevice:1” if desired.

As shown in FIG. 7, it is desirable for both a power service and a projector service (e.g., PowerService.1 702 and ProjectorService.1 704) to be implemented. If the PowerService is off, then any event subscriptions are cancelled, and any action requests are not acknowledged. The states of other services do not constrain the actions of the PowerService. Once the service description is obtained from the indicated URL 706, the ProjectorService provides the URL of where to control 708 the projector. In addition, it allows for the retrieval of resolution and color-depth settings.

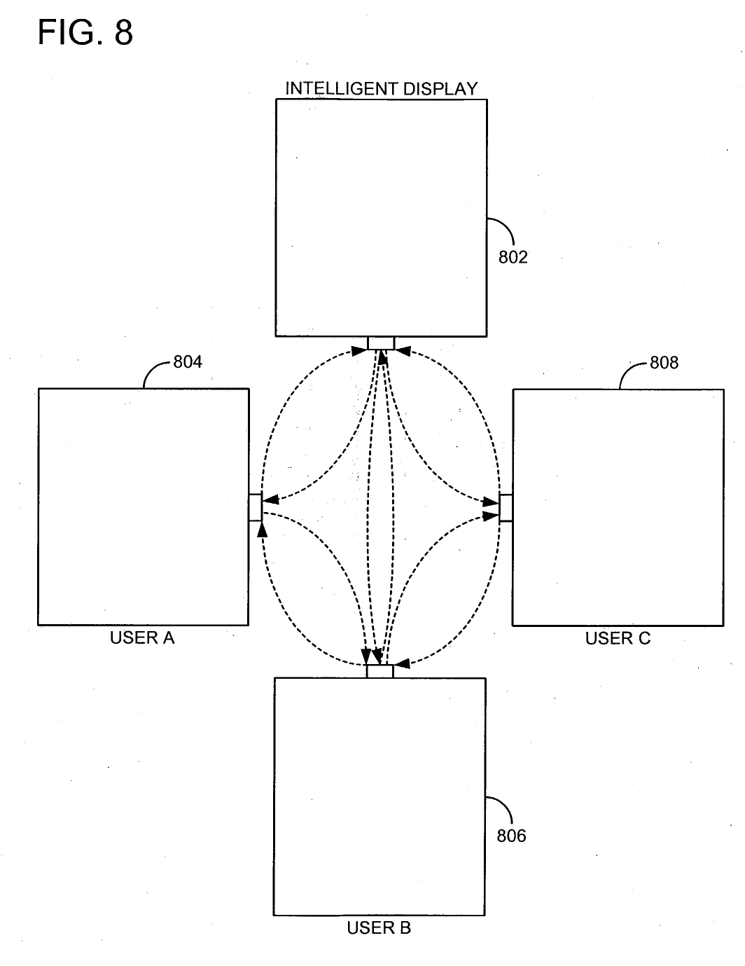

The described technologies operate under several theories of operation. For example, as shown in FIG. 8, upon entering a conference room, User A's and User B's laptops discover the projector. User A takes control of the projector 802 and projects his presentation. User B also connects to the projector as he will present after User A. User A, when he has finished his presentation, passes control of the projector to User B. Once both are done presenting, they disconnect from the projector.

A control point 804 discovers projectors 802 via UPnP Discovery or a projector announces itself. The control point is now able to retrieve the projector's identification so the user can make a decision about which projector to connect to if there are multiple projectors nearby.

Once a controller 804-808 decides which projector they would like to use, they simply connect to the projector. The projector now begins to display the controller's screen. A controller (i.e., a control point) can connect to a projector that is currently projecting another controller's screen. They simply become another “source” feed for the projector. Their screen does not, however, appear on the projector, as they do not “own” the projector at that moment in time. If a user is currently presenting, they cannot be kicked off. However, they can relinquish control of the projector to another individual who is connected. The new individual is now the “owner” of the projector. If the user who had control of the projector simply disconnects, another user can take control of the projector by choosing to make themselves the current source and owner.

FIG. 8 also shows how User B 806 can make a request to project to the plural other control points 804, 808. If the control points support the UPnP device host protocol (e.g., 118), those control points 804, 808 will respond to a discovery announcement (e.g., 202). Similarly, the control points can perform the other functions of an intelligent display (e.g., 204, 206, 208, 216, 218), and begin receiving display rendering from User B. Thus control points may contain intelligent display technology, and act as a control point and/or an intelligent display.

### Service Description Document

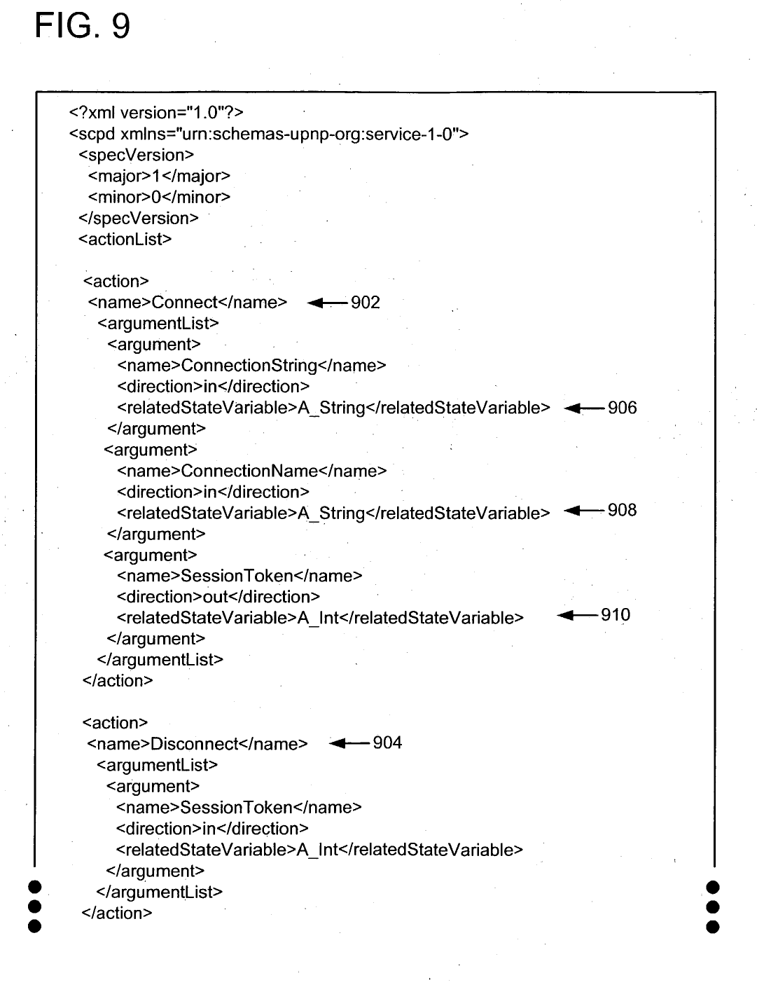

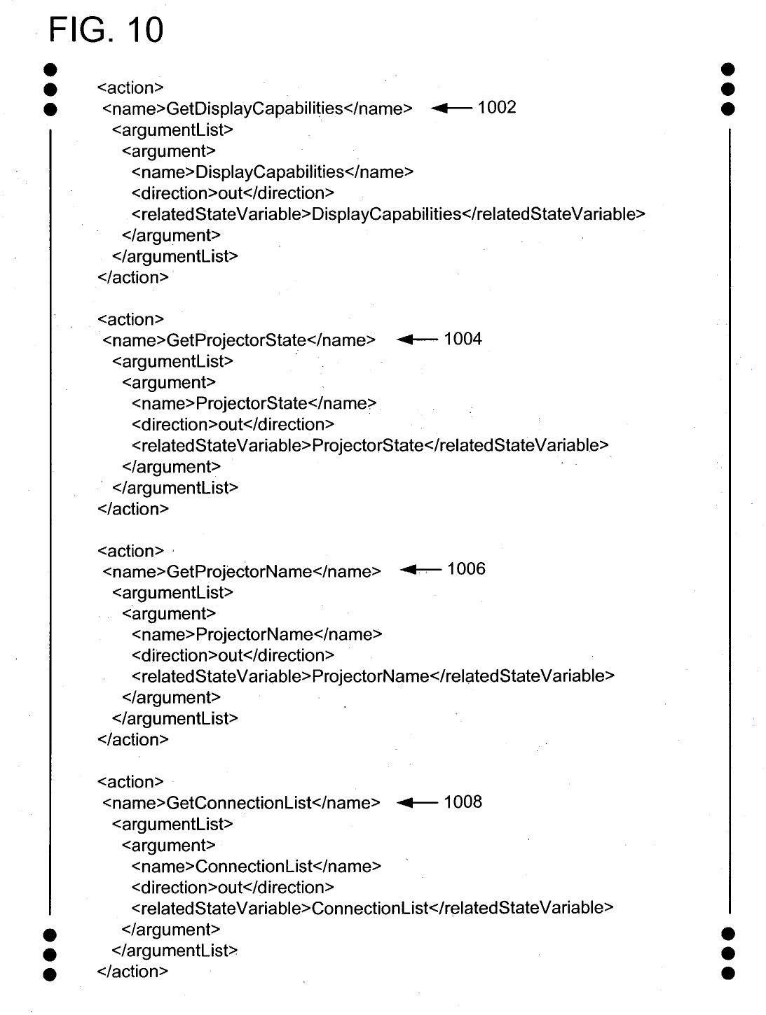

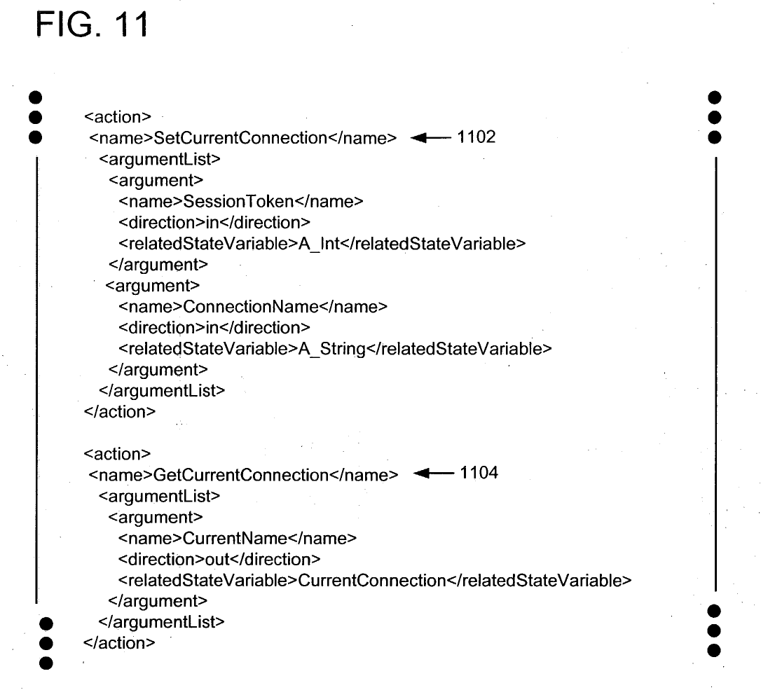

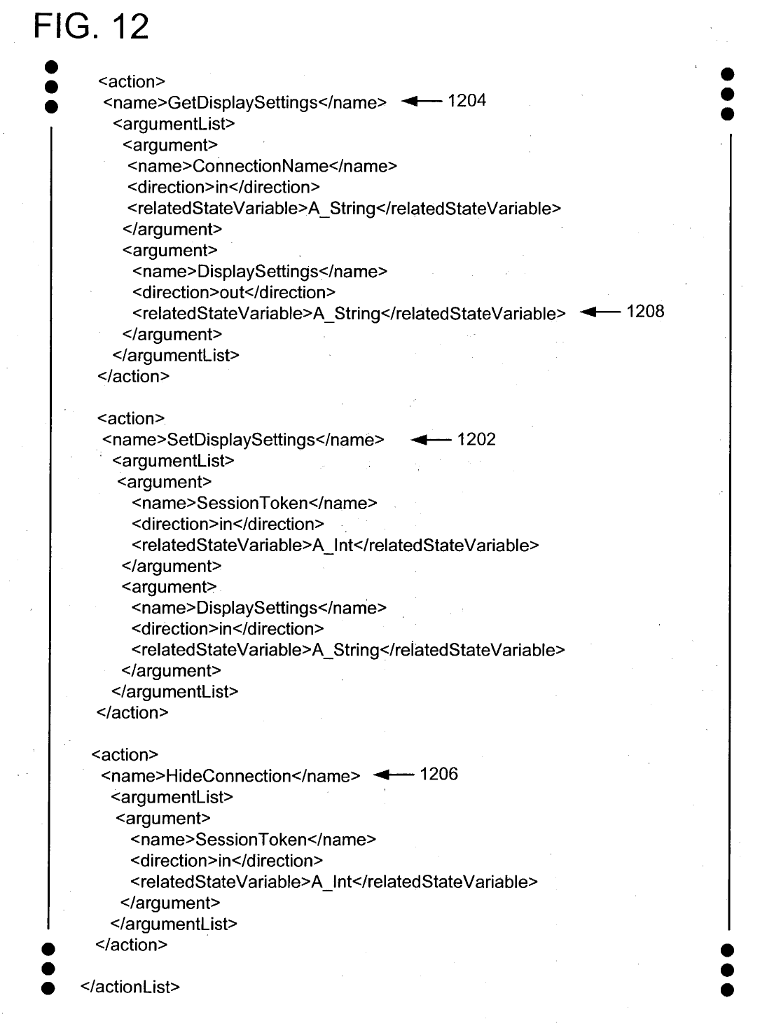

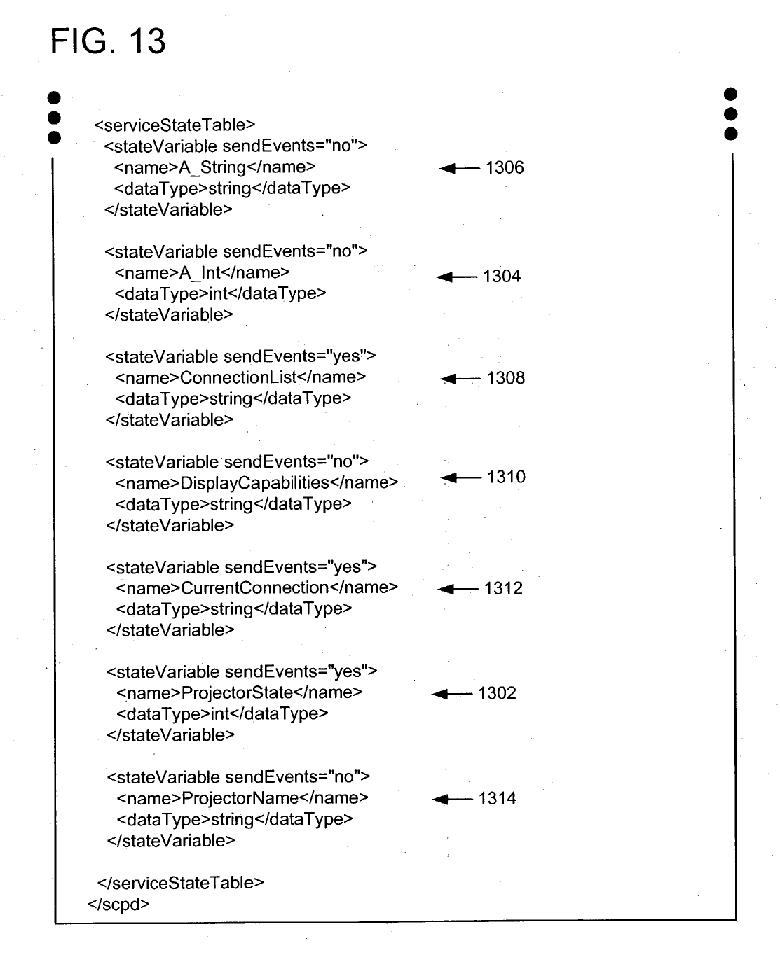

FIGS. 9-13 is a service description for an intelligent display. This service-type enables connecting to an intelligent display (e.g., a projector) 902, disconnecting from a projector 904, retrieval of a projector's display capabilities 1002, setting projector's display settings 1202, retrieving a projector's display settings 1204, maintaining a projector's states 1302-1314, changing the source feed of a projector 1102, retrieving the projector's state 1004, retrieving the current connection of the proj ector 1104, retrieving a projector's name 1006, and “Blanking” a display screen 1206.

The example service type also enables getting a list of other connection points connected to the projector 1008, and contains intelligent display state variables such as a generic integer used to represent a value 1304, a generic string 1306 used to represent a string or list, a list of connected control points 1308, a string of display capabilities 1310, a current controlling control point 1312, and a projector or intelligent display name 1314.

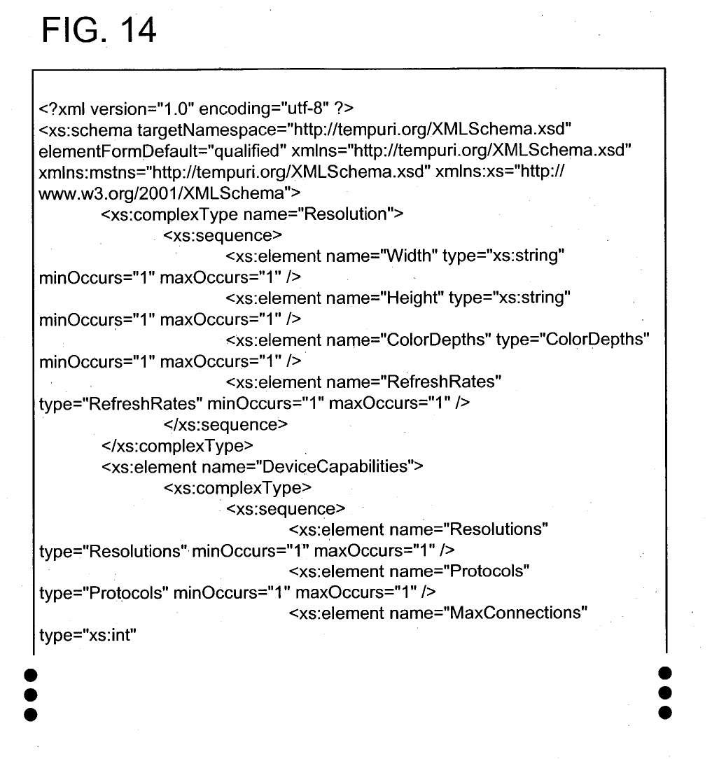

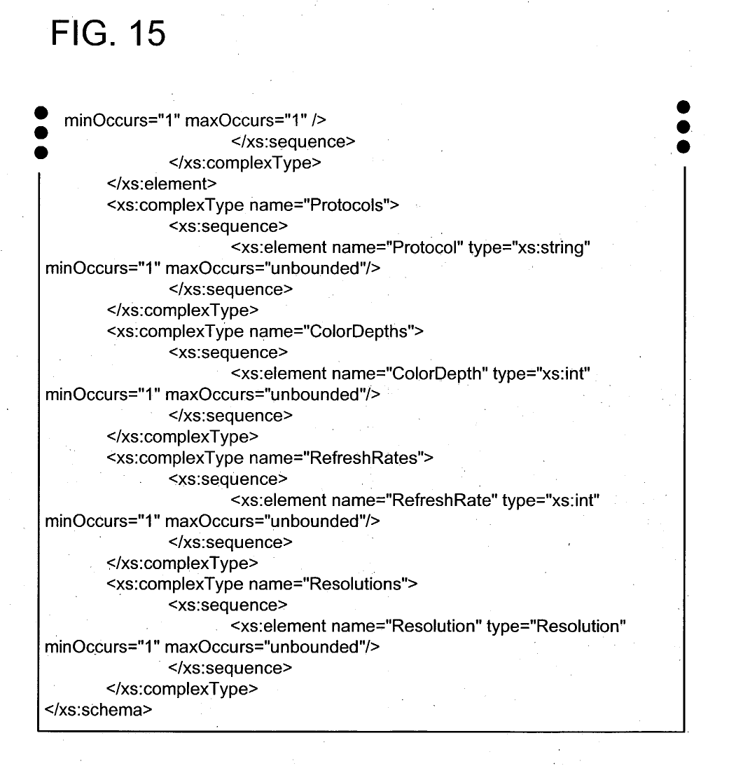

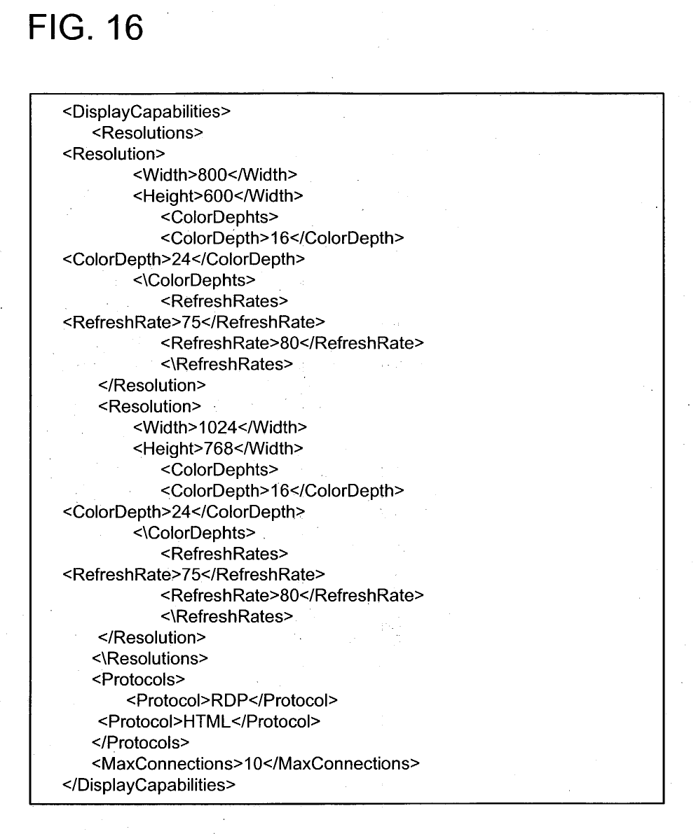

For example, FIG. 14-15 is a schema that defines how to form an XML string that represents the resolutions supported by the string enumerated in the Display Capabilities state variable 1310. Using this schema, a well formed string is shown in FIG. 16. Thus, when the display capabilities are requested by a control point, the serialized well formed string is transmitted over the network, or obtained in memory if available locally.

In another example, Table C is a schema that defines how to form an XML string representing all the user names connected to the projector 1310. A string formed according to the schema is shown in Table D.

TABLE C
<?xml version=“1.0” encoding=“utf-8” ?>
<xs:schema targetNamespace=“http://tempuri.org/XMLSchema.xsd”
elementFormDefault=“qualified” xmlns=
“http://tempuri.org/XMLSchema.xsd”
xmlns:mstns=“http://tempuri.org/XMLSchema.xsd”
xmlns:xs=“http://www.w3.org/2001/XMLSchema”>

<xs:element name=“ConnectionList”>

<xs:complexType>

<xs:sequence>

<xs:element name=“ConnectionName”
type=“xs:string”

minOccurs=“0” maxOccurs=“unbounded”/>

</xs:sequence>

</xs:complexType>

</xs:element>

</xs:schema>

TABLE D

<ConnectionList>

<ConnectionName>tmanion</ConnectionName>
<ConnectionName>VCR</ConnectionName>

</ConnectionList>

The ProjectorState variable 1302, is an integer that represents the current state of the projector. For example, the state could be “Connected”, “Disconnected”, or “Un-initialized.” Please see Table Y for more information on example projector states.

The ProjectorName 1314 is a name or identification string of the projector. The CurrentConnection variable 1312 is a string that represents the current control point connected to the projector. This value is tied to the ConnectionName that was passed in the Connect method.

When certain events happen at the intelligent display, an event is generated and sent by the intelligent display to inform control points. A change in the variables in Table A will cause an event to fire.

TABLE E

| Variable Name | Evented |
|---|---|
| CurrentConnection | Yes |
| ConnectionList | Yes |
| ProjectorState | Yes |

Table A and B contain the methods or actions that a control point can invoke on the intelligent display, thereby causing XML strings to be sent to the intelligent display. These methods and their effects on the state variables, and any error codes are considered.

The connect method 902 initiates a connection to the projector. The method takes a connection string 906 which sets up the connection and a ConnectionName string 908 which describes who/what is connected. The method returns a SessionToken 910 that identifies the connection. The projector uses this token to identify the owner of the projector. The format of the string 906 is up to the protocol being used. In one example, the connection string contains the “ticket” generated by the remote assistance 110. Table F enumerates the arguments, and indicates whether they are input parameters “IN” or output parameters “OUT”, and their related state variables.

TABLE F

| Argument | Direction | relatedStateVariable |
|---|---|---|
| ConnectionString | IN | A_String |
| ConnectionName | IN | A_String |
| SessionToken | OUT | A_Int |

If this method succeeds, it changes the ProjectorState. If it fails, it returns the error shown in Table G.

TABLE G

| errorCode | errorDescription | Description |
|---|---|---|
| 701 | ConnectionRefused | The projector has refused the |
| | | incoming connection request |

The disconnect method disconnects the specified connection from the projector. It takes the arguments described in Table H, and has the error code described in Table I. This method's success depends on whether or not the projector is “Connected.” If this method succeeds, it could affect the ProjectorState, which will fire a connection list event if any other control points remain connected.

TABLE H

| Argument | Direction | relatedStateVariable |
|---|---|---|
| SessionToken | IN | A_Int |

TABLE I

| errorCode | errorDescription | Description |
|---|---|---|
| 702 | NotConnected | The action failed because the |
| | | projector is not connected |

The GetDisplayCapabilities method 1002 gets the DisplayCapabilities enumerated in FIG. 15. The arguments for the method 1102 are enumerated in Table J.

TABLE J

| Argument | Direction | relatedStateVariable |
|---|---|---|
| DisplayCapabilities | OUT | A_string |

The GetProj ectorState method 1004 contains the arguments enumerated in Table K.

TABLE K

| Argument | Direction | relatedStateVariable |
|---|---|---|
| ProjectorState | OUT | ProjectorState |

The GetProjectorName method 1006 returns the Proj ectorName variable (as shown in Table L) and if unsuccessful, returns the error described in Table M.

TABLE L

| Argument | Direction | relatedStateVariable |
|---|---|---|
| ProjectorName | OUT | ProjectorName |

TABLE M

| errorCode | errorDescription | Description |
|---|---|---|
| 706 | InvalidValue | The value specified is invalid |

The GetConnectionList method 1008 returns a list of currently connected users and has the parameters described in Table N.

TABLE N

| Argument | Direction | relatedStateVariable |
|---|---|---|
| ConnectionList | OUT | ConnectionList |

The GetCurrentConnection method 1104 returns the current connection identifier (ConnectionName), as shown in Table P. If the projector is disconnected, then this does not have a value. If no one is connected, then the error described in Table Q is returned.

TABLE P

| Argument | Direction | relatedStateVariable |
|---|---|---|
| CurrentName | OUT | CurrentConnection |

TABLE Q

| errorCode | errorDescription | Description |
|---|---|---|
| 704 | NoCurrentConnection | Currently no one is connected |
| | | to the projector |

The SetCurrentConnection method 1102 gives ownership to the ConnectionName specified in Table R. The SessionToken specified must be the current owner, otherwise the method fails. The method will return the error codes described in Table S.

TABLE R

| Argument | Direction | relatedStateVariable |
|---|---|---|
| SessionToken | IN | A_Int |
| ConnectionName | IN | A_String |

TABLE S

| errorCode | errorDescription | Description |
|---|---|---|
| 703 | InvalidIndex | The index passed in is invalid |
| 705 | ChangeDenied | The change was denied because |
| | | the user is not the current owner |

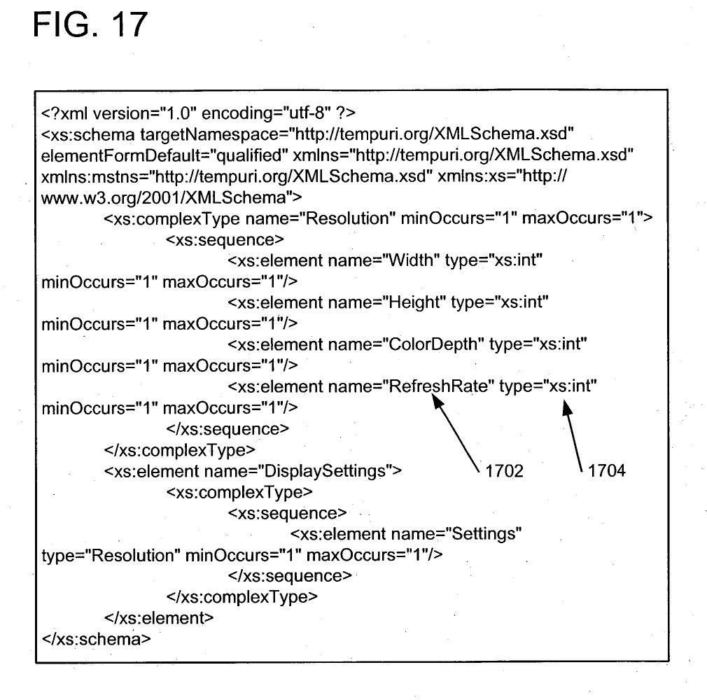

The GetDisplaySettings method 1204 returns the current X, Y resolution, color depth, refresh rate for a given session on the projector, and requires the arguments described in Table T. FIG. 17 is a schema that defines how to form an XML string for the DisplaySettings string 1208 which is returned by the GetDisplaySettings method. In FIG. 17, a “RefreshRate” 1703 element name, has a “data field” 1704 of an integer type. A string formed according to the schema of FIG. 17 is shown in Table U. As shown in Table U, the data field of the RefreshRate element, has been replaced with “instance data” (e.g., 70).

TABLE T

| Argument | Direction | relatedStateVariable |
|---|---|---|
| DisplaySettings | OUT | A_String |

TABLE U

<DisplaySettings>

<Resolution>

<Width>800</Width>
<Height>600</Width>
<ColorDepth>16</ColorDepth>
<RefreshRate>70</RefreshRate>

</Resolution>

</DisplaySettings>

The SetDisplaySettings method 1202 sets the current X, Y resolution, Refresh rate and color depth of the projector and the arguments are set forth in Table V. The format for the XML string is the same as GetDisplaySettings. This method's success depends on whether or not the projector is “Connected.”

TABLE V

| Argument | Direction | relatedStateVariable |
|---|---|---|
| SessionToken | IN | A_Int |
| DisplaySettings | IN | A_String |

The HideConnection method 1206 “blanks” the screen of the given session token. The arguments are set forth in Table W.

TABLE W

| Argument | Direction | relatedStateVariable |
|---|---|---|
| SessionToken | IN | A_Int |

Table X lists error codes common to actions for this service type. If an action results in multiple errors, the most specific error is be returned.

TABLE X

| errorCode | errorDescription | Description |
|---|---|---|
| 401 | Invalid Action | See UPnP Device Architecture |
| | | section on Control. |
| 402 | Invalid Args | See UPnP Device Architecture |
| | | section on Control. |
| 404 | Invalid Var | See UPnP Device Architecture |
| | | section on Control. |
| 501 | Action Failed | See UPnP Device Architecture |
| | | section on Control. |
| 701 | ConnectionRefused | The projector has refused the |
| | | incoming connection request |
| 702 | NotConnected | The action failed because the |
| | | projector is not connected. |
| 704 | NoCurrentConnection | Currently no one is connected |
| | | to the projector |
| 705 | ChangeDenied | The change was denied because |
| | | the user is not the current owner |
| 706 | InvalidResolution | The value specified is not a |
| | | valid resolution |
| 707 | DepthNotSupported | The color depth is not supported |
| | | at this resolution |

Table Y sets forth possible states for a projector.

TABLE Y

| State Code | State Name | State Description |
|---|---|---|
| 400-499 | UPnP State | Reserved for future use |
| 500 | Disconnected | The display is disconnected |
| 501 | Connected | The display has a connection |
| 502 | UnInitialized | The projector is uninitialized |
| 503-699 | Device Standard States | Reserved for future use |
| 700-799 | Vendor Specific States | Reserved for vendor use |

A control point discovers projectors via UPnP discovery or a projector announces itself. The control point is now able to retrieve the projector's identification so the user can make a decision about which projector to connect to if there are multiple projectors out on the network (whether wireless or not). A control point could perfomm the control flow described in Table Z.

TABLE Z

Foreach projector found

GetProjectorName
GetProjectorState

End

Once a controller selects a projector, it connects to the projector as shown in Table AA. The projector now begins to display the controller's screen.

TABLE AA

GetProjectorState
--User action to choose projector --
Connect

A controller can connect to a projector that is currently projecting another controller screen as shown above in Table AA. They simply become another “source” feed for the projector. Their screen does not, however, appear on the projector, as they do not “own” the projector at that moment in time.

If a user is currently presenting, they cannot be kicked off. However, they can relinquish control of the projector to another individual who is connected as shown in Table BB. The new individual is now the “owner” of the projector.

TABLE BB

GetProjectorState
GetConnectionList

-- Parse the list --
-- Display info to user --

SetCurrentConnection to user specified

If the user who had control of the projector simply disconnects, another user can take control of the projector by simply choosing to make themselves the current source and owner, as shown in Table CC.

TABLE CC

GetProjectorState
GetConnectionList

-- Parse the list --
-- Display info to user --

Disconnect occurs
-- Display info to user --
SetOwnership to my connection

If a user owns the projector or the projector is not owned, then the properties of the projector can be changed. The user is able to change the X, Y resolution of the projector as shown in Table DD.

TABLE DD

GetProjectorState
GetDisplayCapabilities

-- Display info to user --

SetDisplaySettings

The user is able to change the color depth of the projector as shown in Table EE.

TABLE EE

GetProjectorState
GetDisplayCapabilities

-- Display info to user --

SetDisplaySettings

### Computing Environment

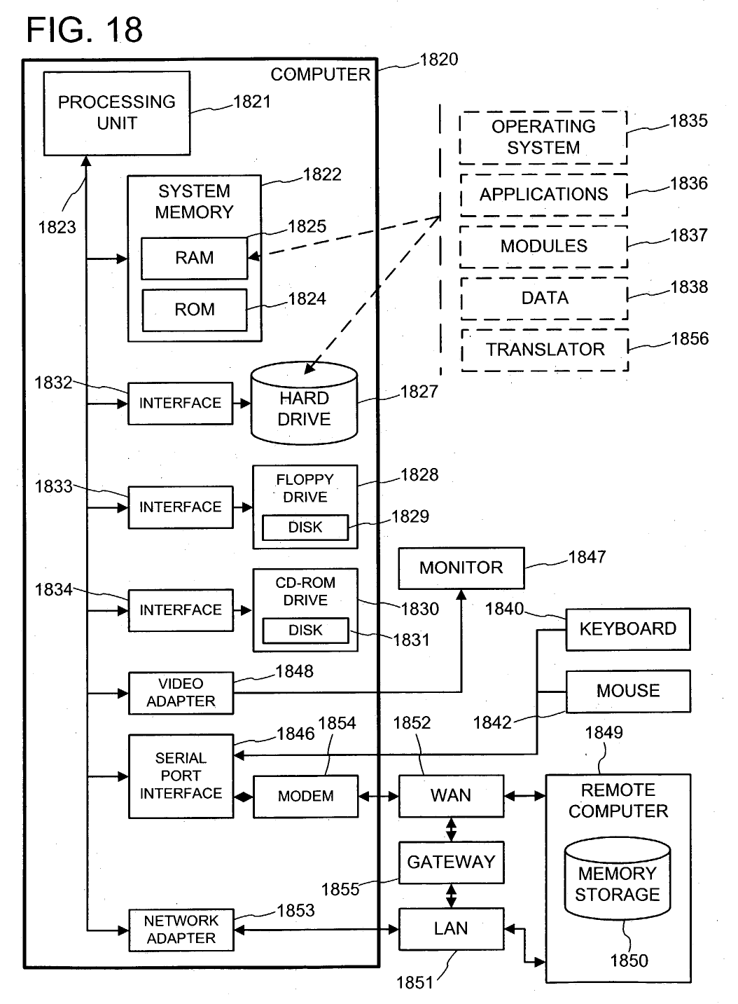

FIG. 18 and the following discussion are intended to provide a brief, general description of a suitable computing environment for an intelligent display or control point. While theses technologies are be described in the general context of computer-executable instructions of a computer program that runs on a computer and/or network device, those skilled in the art will recognize that the invention also may be implemented in combination with other program modules. Generally, program modules include routines, programs, components, data structures, etc. that perform particular tasks or implement particular abstract data types. Moreover, those skilled in the arts will appreciate that the invention may be practiced with other computer system configurations, including multiprocessor systems, microprocessor-based electronics, minicomputers, mainframe computers, network appliances, wireless devices, and the like. The extensions can be practiced in networked computing environments, or on stand-alone computers.

With reference to FIG. 18, an exemplary system for implementation includes a conventional computer 1820 (such as personal computers, laptops, servers, PDAs, mainframes, and other variety computers, and assorted electronic devices) includes a processing unit 1821, a system memory 1822, and a system bus 1823 that couples various system components including the system memory to the processing unit 1821. The processing unit may be any of various commercially available processors, including Intel x86, Pentium and compatible microprocessors from Intel and others, including Cyrix, AMD and Nexgen; Alpha from Digital; MIPS from MIPS Technology, NEC, IDT, Siemens, and others; and the PowerPC from IBM and Motorola. Dual microprocessors and other multi-processor architectures also can be used as the processing unit 1821.

The system bus may be any of several types of bus structure including a memory bus or memory controller, a peripheral bus, and a local bus using any of a variety of conventional bus architectures such as PCI, VESA, AGP, Microchannel, ISA and EISA, to name a few. The system memory includes read only memory (ROM) 1824 and random access memory (RAM) 1825. A basic input/output system (BIOS), containing the basic routines that help to transfer information between elements within the computer 1820, such as during start-up, is stored in ROM 1824.

The computer 1820 further includes a hard disk drive 1827, a magnetic disk drive 1828, e.g., to read from or write to a removable disk 1829, and an optical disk drive 1830, e.g., for reading a CD-ROM disk 1831 or to read from or write to other optical media. The hard disk drive 1827, magnetic disk drive 1828, and optical disk drive 1830 are connected to the system bus 1823 by a hard disk drive interface 1832, a magnetic disk drive interface 1833, and an optical drive interface 1834, respectively. The drives and their associated computer-readable media provide nonvolatile storage of data, data structures, computer-executable instructions, etc. for the computer 1820. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 1825, including an operating system 1835, one or more application programs 1836, other program modules 1837, and program data 1838; in addition to an implementation 1856.

A user may enter commands and information into the computer 1820 through a keyboard 1840 and pointing device, such as a mouse 1842. These and other input devices are often connected to the processing unit 1821 through a serial port interface 1846 that is coupled to the system bus, but may be connected by other interfaces, such as a parallel port, game port or a universal serial bus (USB). A monitor 1847 or other type of display device is also connected to the system bus 1823 via an interface, such as a video adapter 1848. In addition to the monitor, computers typically include other peripheral output devices (not shown), such as speakers and printers.

The computer 1820 operates in a networked environment using logical connections to one or more remote computers, such as a remote computer 1849. The remote computer 1849 may be a server, a router, a peer device or other common network node, and typically includes many or all of the elements described relative to the computer 1820, although only a memory storage device 1850 has been illustrated. The logical connections depicted include a local area network (LAN) 1851 and a wide area network (WAN) 1852. Such networking environments are commonplace in offices, enterprise-wide computer networks, intranets and the Internet.

When used in a LAN networking environment, the computer 1820 is connected to the local network 1851 through a network interface or adapter 1853, and or other wireless network cards. When used in a WAN networking environment, the computer 1820 typically includes a modem 1854 or other means for establishing communications (e.g., via the LAN 1851 and a gateway or proxy server 1855) over the wide area network 1852, such as the Internet. The modem 1854, which may be internal or external, is connected to the system bus 1823 via the serial port interface 1846. In a networked environment, program modules depicted relative to the computer 1820, or portions thereof, may be stored in the remote memory storage device. It will be appreciated that the network connections shown are exemplary and other means of establishing a communications link between the computers may be used.

### Alternatives

Having described and illustrated the principles of our invention with reference to illustrated examples, it will be recognized that the examples can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa. Techniques from one example can be incorporated into any of the other examples.

In view of the many possible embodiments to which the principles of our invention may be applied, it should be recognized that the details are illustrative only and should not be taken as limiting the scope of our invention. Rather, we claim as our invention all such embodiments as may come within the scope and spirit of the following claims and equivalents thereto.

We claim:

1. A computer readable storage medium containing a schema data structure used to form XML strings or verify XML strings used in communicating service requests, the schema data structure comprising:
a connection action identifier with an argument list identifier with a connection string argument identifier with a string input value identifier, a connection name argument identifier with a string input value identifier, and a session token argument identifier with an integer output value identifier;
a disconnect action identifier with a session token argument identifier with an integer input value identifier;
a get display capabilities action identifier with a display capabilities argument identifier with a string output value identifier; and
a get projector state action identifier with a projector state argument identifier with an integer output value identifier.

2. The computer-readable medium of claim 1 further comprising:
a get projector name action identifier with a projector name argument identifier with a string output value identifier; and
a get connection list identifier action identifier with a connection list identifier argument identifier with a string output value identifier.

3. The computer-readable medium of claim 2 further comprising:
a set current connection action identifier with an argument list identifier with a session token argument identifier with an integer input value identifier, and a connection name argument identifier with a string input value identifier; and
a get current connection action identifier with a current name argument identifier with a string output value identifier.

4. The computer-readable medium of claim 3, further comprising:
a get display settings action identifier with an argument list identifier with a connection name argument identifier with a string output value identifier, and a display settings argument identifier with a string output value identifier; and
a set display settings action identifier with an argument list identifier with a session token argument identifier with an integer input value identifier, and a display settings argument identifier with a string output value identifier; and
a hide connection action identifier with a session token argument identifier with an integer input value identifier.

5. The computer-readable medium of claim 1 wherein the data structure is used by a control point to form XML strings to control an intelligent display.

6. The computer-readable medium of claim 1 wherein the data structure is used by a control point to form XML strings to control the display of another control point.

7. The computer-readable medium of claim 1 wherein the data structure is used by a control point to form XML strings to control the display of plural other control points.

8. The computer-readable medium of claim 7 wherein the data structure is transmitted from an intelligent display to a control point, upon receiving a request from the control point for a service description.

9. The computer-readable medium of claim 7 wherein the data structure is used by an intelligent display to verify that a received XML string is a well formed service request.

10. A computerized method comprising:
requesting a service description;
receiving the service description;
storing the service description;
creating a service request according to a format of the service description; and
sending the service request;
wherein the service description comprises the following:
<?xml version=“1.0”?>
<scpd xmlns=“urn:schemas-upnp-org:service-1-0”>
<specVersion>
<major>1</major>
<minor>0</minor>
</specVersion>
<actionList>
<action>
<name>Connect</name>
<argumentList>
<argument>
<name>ConnectionString</name>
<direction>in</direction>
<relatedStateVariable>A_String</relatedStateVariable>
</argument>
<argument>
<name>ConnectionName</name>
<direction>in</direction>
<relatedStateVariable>A_String</relatedStateVariable>
</argument>
<argument>
<name>SessionToken</name>
<direction>out</direction>
<relatedStateVariable>A_Int</relatedStateVariable>
</argument>
</argumentList>
</action>
<action>
<name>Disconnect</name>
<argumentList>
<argument>
<name>SessionToken</name>
<direction>in</direction>
<relatedStateVariable>A_Int</relatedStateVariable>
</argument>
</argumentList>
</action>
<action>
<name>GetDisplayCapabilities</name>
<argumentList>
<argument>
<name>DisplayCapabilities</name>
<direction>out</direction>
<relatedStateVariable>DisplayCapabilities</relatedStateVariable>
</argument>
</argumentList>
</action>
<action>
<name>GetProjectorState</name>
<argumentList>
<argument>
<name>ProjectorState</name>
<direction>out</direction>
<relatedStateVariable>ProjectorState</relatedStateVariable>
</argument>
</argumentList>
</action>
<action>
<name>GetProjectorName</name>
<argumentList>
<argument>
<name>ProjectorName</name>
<direction>out</direction>
<relatedStateVariable>ProjectorName</relatedStateVariable>
</argument>
</argumentList>
</action>
<action>
<name>GetConnectionList</name>
<argumentList>
<argument>
<name>ConnectionList</name>
<direction>out</direction>
<relatedStateVariable>ConnectionList</relatedStateVariable>
</argument>
</argumentList>
</action>
<action>
<name>SetCurrentConnection</name>
<argumentList>
<argument>
<name>SessionToken</name>
<direction>in</direction>
<relatedStateVariable>A_Int</relatedStateVariable>
</argument>
<argument>
<name>ConnectionName</name>
<direction>in</direction>
<relatedStateVariable>A_String</relatedStateVariable>
</argument>
</argumentList>
</action>
<action>
<name>GetCurrentConnection</name>
<argumentList>
<argument>
<name>CurrentName</name>
<direction>out</direction>
<relatedStateVariable>CurrentConnection</relatedStateVariable>
</argument>
</argumentList>
</action>
<action>
<name>GetDisplaySettings</name>
<argumentList>
<argument>
<name>ConnectionName</name>
<direction>in</direction>
<relatedStateVariable>A_String</relatedStateVariable>
</argument>
<argument>
<name>DisplaySettings</name>
<direction>out</direction>
<relatedStateVariable>A_String</relatedStateVariable>
</argument>
</argumentList>
</action>
<action>
<name>SetDisplaySettings</name>
<argumentList>
<argument>
<name>SessionToken</name>
<direction>in</direction>
<relatedStateVariable>A_Int</relatedStateVariable>
</argument>
<argument>
<name>DisplaySettings</name>
<direction>in</direction>
<relatedStateVariable>A_String</relatedStateVariable>
</argument>
</argumentList>
</action>
<action>
<name>HideConnection</name>
<argumentList>
<argument>
<name>SessionToken</name>
<direction>in</direction>
<relatedStateVariable>A_Int</relatedStateVariable>
</argument>
</argumentList>
</action>
</actionList>
<serviceStateTable>
<stateVariable sendEvents=“no”>
<name>A_String</name>
<dataType>string</dataType>
</stateVariable>
<stateVariable sendEvents=“no”>
<name>A_Int</name>
<dataType>int</dataType>
</stateVariable>
<stateVariable sendEvents=“yes”>
<name>ConnectionList</name>
<dataType>string</dataType>
</stateVariable>
<stateVariable sendEvents=“no”>
<name>DisplayCapabilities</name>
<dataType>string</dataType>
</stateVariable>
<stateVariable sendEvents=“yes”>
<name>CurrentConnection</name>
<dataType>string</dataType>
</stateVariable>
<stateVariable sendEvents=“yes”>
<name>ProjectorState</name>
<dataType>int</dataType>
</stateVariable>
<stateVariable sendEvents=“no”>
<name>ProjectorName</name>
<dataType>string</dataType>
</stateVariable>
</serviceStateTable>
</scpd>.

11. The computerized method of claim 10 wherein a response to the sent service request is received as an XML string with instance data in place of below data fields, the XML string comprising:
<DisplayCapabilities>
<Resolutions>
<Resolution>
<Width>data field</Width>
<Height>data field</Width>
<ColorDephts>
<ColorDepth>data field</ColorDepth>
<ColorDepth>data field</ColorDepth>
<\ColorDephts>
<RefreshRates>
<RefreshRate>data field</RefreshRate>
<RefreshRate>data field</RefreshRate>
<\RefreshRates>
</Resolution>
<Resolution>
<Width>data field</Width>
<Height>data field</Width>
<ColorDephts>
<ColorDepth>data field</ColorDepth>
<ColorDepth>data field</ColorDepth>
<\ColorDephts>
<RefreshRates>
<RefreshRate>data field</RefreshRate>
<RefreshRate>data field</RefreshRate>
<\RefreshRates>
</Resolution>
<\Resolutions>
<Protocols>
<Protocol>data field</Protocol>
<Protocol>data field</Protocol>
</Protocols>
<MaxConnections>data field</MaxConnections>
</DisplayCapabilities>.

12. The computerized method of claim 10 wherein a response to the sent service request is received as an XML string with instance data in place of below data fields, the XML string comprising:
<ConnectionList>
<ConnectionName>data field</ConnectionName>
<ConnectionName>data field</ConnectionName>
</ConnectionList>.

13. The computerized method of claim 10 wherein the method is being performed by a laptop computer over a wireless network in order to control an intelligent display.

14. The computerized method of claim 13 wherein the intelligent display is a laptop.

15. The computerized method of claim 13 wherein the intelligent display is a projector.

16. An intelligent display communicating over a wireless network, the communications comprising:
an XML service request with instance data replacing the following data fields, the XML service request comprising:
<action>
<name>Connect</name>
<argumentList>
<argument>
<name>ConnectionString</name>
<direction>in</direction>
<relatedStateVariable>data
field</relatedStateVariable>
</argument>
<argument>
<name>ConnectionName</name>
<direction>in</direction>
<relatedStateVariable>data
field</relatedStateVariable>
</argument>
<argument>
<name>SessionToken</name>
<direction>out</direction>
<relatedStateVariable>data
field</relatedStateVariable>
</argument>
</argumentList>
</action>;
an XML service request with instance data replacing the following data field, the XML service request comprising:
<action>
<name>Disconnect</name>
<argumentList>
<argument>
<name>SessionToken</name>
<direction>in</direction>
<relatedStateVariable>data
field</relatedStateVariable>
</argument>
</argumentList>
</action>;
an XML service request with instance data replacing the following data field, the XML service request comprising:
<action>
<name>GetDisplayCapabilities</name>
<argumentList>
<argument>
<name>DisplayCapabilities</name>
<direction>out</direction>
<relatedStateVariable>data
field</relatedStateVariable>
</argument>
</argumentList>
</action>; and
an XML service request with instance data replacing the following data field, the XML service request comprising:
<action>
<name>GetProjectorState</name>
<argumentList>
<argument>
<name>ProjectorState</name>
<direction>out</direction>
<relatedStateVariable>data
field</relatedStateVariable>
</argument>
</argumentList>
</action>.

17. The intelligent display of claim 16, wherein the communications are further comprising:
an XML service request with instance data replacing the following data field, the XML service request comprising:
<action>
<name>GetProjectorName</name>
<argumentList>
<argument>
<name>ProjectorName</name>
<direction>out</direction>
<relatedStateVariable>data
field</relatedStateVariable>
</argument>
</argumentList>
</action>.

18. The intelligent display of claim 17, wherein the communications are further comprising:
an XML service request with instance data replacing the following data field, the XML service request comprising:
<action>
<name>GetConnectionList</name>
<argumentList>
<argument>
<name>ConnectionList</name>
<direction>out</direction>
<relatedStateVariable>data
field</relatedStateVariable>
</argument>
</argumentList>
</action>.

19. The intelligent display of claim 17, wherein the communications are further comprising:
an XML service request with instance data replacing the following data fields, the XML service request comprising:
<action>
<name>SetCurrentConnection</name>
<argumentList>
<argument>
<name>SessionToken</name>
<direction>in</direction>
<relatedStateVariable>data
field</relatedStateVariable>
</argument>
<argument>
<name>ConnectionName</name>
<direction>in</direction>
<relatedStateVariable>data
field</relatedStateVariable>
</argument>
</argumentList>
</action>.

20. The intelligent display of claim 17, wherein the communications are further comprising:
an XML service request with instance data replacing the following data field, the XML service request comprising:
<action>
<name>GetCurrentConnection</name>
<argumentList>
<argument>
<name>CurrentName</name>
<direction>out</direction>
<relatedStateVariable>data field</relatedStateVariable>
</argument>
</argumentList>
</action>.

21. The intelligent display of claim 17, wherein the communications are further comprising:
an XML service request with instance data replacing the following data fields, the XML service request comprising:
<action>
<name>GetDisplaySettings</name>
<argumentList>
<argument>
<name>ConnectionName</name>
<direction>in</direction>
<relatedStateVariable>data
field</relatedStateVariable>
</argument>
<argument>
<name>DisplaySettings</name>
<direction>out</direction>
<relatedStateVariable>data
field</relatedStateVariable>
</argument>
</argumentList>
</action>.

22. The intelligent display of claim 17, wherein the communications are further comprising:
an XML service request with instance data replacing the following data fields, the XML service request comprising:
<action>
<name>SetDisplaySettings</name>
<argumentList>
<argument>
<name>SessionToken</name>
<direction>in</direction>
<relatedStateVariable>data
field</relatedStateVariable>
</argument>
<argument>
<name>DisplaySettings</name>
<direction>in</direction>
<relatedStateVariable>data
field</relatedStateVariable>
</argument>
</argumentList>
</action>.

23. The intelligent display of claim 17, wherein the communications are further comprising:
an XML service request with instance data replacing the following data field, the XML service request comprising:
<action>
<name>HideConnection</name>
<argumentList>
<argument>
<name>SessionToken</name>
<direction>in</direction>
<relatedStateVariable>data
field</relatedStateVariable>
</argument>
</argumentList>
</action>.
